(19) United States
(12) Patent Application Publication
(10) Pub. No.: US 2021/0201000 A1
(43) Pub. Date: Jul. 1, 2021

(54) FACIAL RECOGNITION METHOD AND DEVICE

(71) Applicant: HUAWEI TECHNOLOGIES CO., LTD., Shenzhen (CN)

(72) Inventors: Xiaolin HUANG, Shenzhen (CN); Wei HUANG, Shanghai (CN); Gang LIU, Shenzhen (CN); Xin HU, Shenzhen (CN)

(73) Assignee: HUAWEI TECHNOLOGIES CO., LTD., Shenzhen (CN)

(21) Appl. No.: 17/202,726

(22) Filed: Mar. 16, 2021

Related U.S. Application Data
(63) Continuation of application No. PCT/CN2019/106216, filed on Sep. 17, 2019.

(30) Foreign Application Priority Data
Sep. 18, 2018 (CN) 201811090801.6

(51) Int. Cl. G06K 9/00; G06K 9/62; G06K 9/46

(52) U.S. Cl. CPC G06K 9/00288; G06K 9/00268; G06K 2009/4695; G06K 9/46; G06K 9/6262

(57) ABSTRACT

A facial recognition method and device, and relate to the field of computer vision in artificial intelligence (AI). The method includes: obtaining a first face image and a second face image; determining whether a modality of the first face image is the same as a modality of the second face image; if the modality of the first face image is different from the modality of the second face image, separately mapping the first face image and the second face image to a cross-modal space to obtain a first sparse facial feature of the first face image in the cross-modal space and a second sparse facial feature of the second face image in the cross-modal space; and performing facial recognition on the first face image based on the first sparse facial feature and the second sparse facial feature.

### CROSS-REFERENCE TO RELATED APPLICATIONS

This application is a continuation of International Application No. PCT/CN2019/106216, filed on Sep. 17, 2019, which claims priority to Chinese Patent Application No. 201811090801.6, filed on Sep. 18, 2018. The disclosures of the aforementioned applications are hereby incorporated by reference in their entireties.

### TECHNICAL FIELD

The embodiments relate to the field of computer technologies, and in particular, to a facial recognition method and device.

### BACKGROUND

Because a biometric feature—based recognition technology of facial recognition is contactless, the technology has a broad development and application prospect in the vehicle field. In-vehicle facial recognition is a technology of performing identity authentication or identity searching by using a camera inside a vehicle. A conventional facial recognition technology obtains a face image in a visible light modality. Because an in-vehicle scenario of poor lighting in a garage or at night, for example, often occurs, a degree of recognizing an identity of a character using a face image in the visible light modality in the in-vehicle scenario is relatively low. Therefore, a near-infrared camera that is not affected by ambient light is used in most cases of the in-vehicle scenario.

The near-infrared camera emits infrared light that is invisible to a naked eye, to illuminate a photographed object and generate an image obtained through infrared reflection. Therefore, an image that is invisible to the naked eye can be photographed even in a dark environment, and this is applicable to in-vehicle scenarios. However, images photographed by the near-infrared camera and a visible light camera come from different modalities. Because photosensitivity processes of cameras in different modalities are different, there is a relatively large difference between images obtained by the cameras in different modalities for a same object. Consequently, a recognition degree of in-vehicle facial recognition is reduced. For example, a user has performed identity authentication on an in-vehicle device by using a face image in the visible light modality. When the same user performs identity authentication on the same in-vehicle device by using a face image in a near-infrared modality, because there is a relatively large difference between the image in the near-infrared modality and the image in the visible light modality, it is very likely that authentication on an identity of the user cannot succeed.

At a present stage, most cross-modal facial recognition methods use a deep learning algorithm that is based on a convolutional neural network. In the method, same preprocessing is first performed on a face image in a visible light modality and a face image in a near-infrared modality, and then a deep convolutional neural network is pretrained by using a preprocessed face image in the visible light modality, to provide prior knowledge for cross-modal image-based deep convolutional neural network training. Then the face image in the visible light modality and the face image in the near-infrared modality form a triplet according to a preset rule, and a difficult triplet difficult to distinguish in the pretrained cross-modal image-based deep convolutional neural network is selected. The selected difficult triplet is input into the pretrained cross-modal image-based deep convolutional neural network to perform fine tuning, and selection and fine tuning of the difficult triplet are iterated until performance of the cross-modal image-based deep convolutional neural network is no longer improved. Finally, cross-modal facial recognition is performed by using a trained cross-modal image-based deep convolutional neural network model.

The difficult triplet is an important factor that affects performance of the foregoing algorithm. However, in actual application, because a large amount of training data is required for deep learning of the convolutional neural network, it is difficult to select a difficult sample triplet. Therefore, overfitting of the network tends to occur, and a degree of identity recognition is reduced. In addition, calculation of the convolutional neural network needs to be accelerated by using a graphics processing unit (GPU). On a device without a GPU, a neural network—based algorithm operation speed is relatively low, and a real-time requirement cannot be met.

### SUMMARY

Embodiments provide a facial recognition method and device, so that a cross-modal facial recognition speed can be increased, thereby meeting a real-time requirement.

According to a first aspect, an embodiment provides a facial recognition method. The method includes: obtaining a first face image and a second face image, where the first face image is a current face image obtained by a camera, and the second face image is a stored reference face image; determining whether a modality of the first face image is the same as a modality of the second face image; if the modality of the first face image is different from the modality of the second face image, separately mapping the first face image and the second face image to a cross-modal space, to obtain a first sparse facial feature of the first face image in the cross-modal space and a second sparse facial feature of the second face image in the cross-modal space, where the cross-modal space is a color space in which both a feature of the first face image and a feature of the second face image may be represented; and performing facial recognition on the first face image based on the first sparse facial feature and the second sparse facial feature.

In this manner, the first face image and the second face image in different modalities are mapped to the same cross-modal space by using a sparse representation method, and then facial recognition is performed on the first face image based on the first sparse facial feature obtained by mapping the first face image and the second sparse facial feature of the second face image. This facial recognition manner does not depend on acceleration of a graphical processing unit (GPU), reducing a requirement on a hardware device, increasing a facial recognition speed, and meeting a real-time requirement on facial recognition. In addition, the sparse representation method has a relatively low requirement on a data volume, so that an overfitting problem can be avoided.

With reference to the first aspect, in an optional implementation, the separately mapping of the first face image and the second face image to a cross-modal space, to obtain a first sparse facial feature of the first face image in the cross-modal space and a second sparse facial feature of the second face image in the cross-modal space includes: obtaining a first dictionary corresponding to the modality of the first face image and a second dictionary corresponding to the modality of the second face image; mapping the first face image to the cross-modal space based on the first dictionary corresponding to the modality of the first face image, to obtain the first sparse facial feature of the first face image in the cross-modal space; and mapping the second face image to the cross-modal space based on the second dictionary corresponding to the modality of the second face image, to obtain the second sparse facial feature of the second face image in the cross-modal space.

With reference to the first aspect, in an optional implementation, the obtaining of a first dictionary corresponding to the modality of the first face image and a second dictionary corresponding to the modality of the second face image includes: obtaining a feature representation matrix of a face image sample in the cross-modal space based on a first facial feature, a second facial feature, and an initialization dictionary by using a matching pursuit (MP) algorithm, where the first facial feature is a facial feature of the face image sample in the modality of the first face image, and the second facial feature is a facial feature of the face image sample in the modality of the second face image; and determining, based on the first facial feature, the second facial feature, and the feature representation matrix by using a method of optimal directions (MOD) algorithm, the first dictionary corresponding to the modality of the first face image and the second dictionary corresponding to the modality of the second face image. In this manner, the first dictionary corresponding to the modality of the first face image and the second dictionary corresponding to the modality of the second face image may be determined at the same time, so that a facial recognition speed is increased.

With reference to the first aspect, in an optional implementation, the obtaining of a feature representation matrix of the face image sample in the cross-modal space based on the first facial feature, the second facial feature, and an initialization dictionary by using an MP algorithm includes: solving a formula \hat{x}ᵢ=argₓ^{min}∥yᵢ-D₍₀₎x∥₂² subject to ∥x∥ₙ≤K by using the MP algorithm, to obtain the feature representation matrix of the face image sample in the cross-modal space, where 1<i<M, yᵢ is an i^{th} column vector in a matrix Y including the first facial feature and the second facial feature, the first row vector to an M^{th} row vector in the matrix Y are the first facial feature, an (M+1)^{th} row vector to a (2M)^{th} row vector are the second facial feature, \hat{x}ᵢ is an i^{th} column vector in the feature representation matrix in the cross-modal space, D₍₀₎ is the initialization dictionary, n represents a constraint manner of sparsing, and K is sparsity.

With reference to the first aspect, in an optional implementation, the determining, based on the first facial feature, the second facial feature, and the feature representation matrix by using an MOD algorithm, the first dictionary corresponding to the modality of the first face image and the second dictionary corresponding to the modality of the second face image includes: solving a formula D=arg_{X}^{min}∥Y−DX∥_{F}²=YX^{T}(XX^{T})⁻¹ by using the MOD algorithm, to obtain the first dictionary corresponding to the modality of the first face image and the second dictionary corresponding to the modality of the second face image, where D is a matrix including the first dictionary corresponding to the modality of the first face image and the second dictionary corresponding to the modality of the second face image, and X is the feature representation matrix.

With reference to the first aspect, in an optional implementation, D includes M column vectors and 2M row vectors, a matrix including the first row vector to an M^{th} row vector is the first dictionary corresponding to the modality of the first face image, and a matrix including an (M+1)^{th} row vector to a (2M)^{th} row vector is the second dictionary corresponding to the modality of the second face image.

With reference to the first aspect, in an optional implementation, the mapping of the first face image to the cross-modal space based on the first dictionary corresponding to the modality of the first face image, to obtain the first sparse facial feature of the first face image in the cross-modal space includes: determining, based on the first dictionary corresponding to the modality of the first face image and a penalty coefficient, a first projection matrix corresponding to the modality of the first face image; and calculating the first sparse facial feature of the first face image in the cross-modal space by using the first projection matrix corresponding to the modality of the first face image and the first face image.

With reference to the first aspect, in an optional implementation, the mapping of the second face image to the cross-modal space based on the second dictionary corresponding to the modality of the second face image, to obtain the second sparse facial feature of the second face image in the cross-modal space includes: determining, based on the second dictionary corresponding to the modality of the second face image and a penalty coefficient, a second projection matrix corresponding to the modality of the second face image; and calculating the second sparse facial feature of the second face image in the cross-modal space by using the second projection matrix corresponding to the modality of the second face image and the second face image.

With reference to the first aspect, in an optional implementation, the determining whether a modality of the first face image is the same as a modality of the second face image includes: separately transforming the first face image and the second face image from a red-green-blue RGB color space to a YCbCr space of a luma component, a blue-difference chroma component, and a red-difference chroma component; determining a color coefficient value of the first face image and a color coefficient value of the second face image based on a value of the first face image in the YCbCr space and a value of the second face image in the YCbCr space; and determining, based on the color coefficient value of the first face image and the color coefficient value of the second face image, whether the modality of the first face image is the same as the modality of the second face image.

With reference to the first aspect, in an optional implementation, that the modality of the first face image is different from the modality of the second face image means that one of the color coefficient value of the first face image and the color coefficient value of the second face image is greater than a first threshold, and the other color coefficient value is not greater than the first threshold.

With reference to the first aspect, in an optional implementation, the sparsing is a manner of representing an original face image feature by using a linear combination of column vectors selected from a dictionary, and a manner of selecting a column vector is one of 0-norm constraint, 1-norm constraint, and 2-norm constraint.

With reference to the first aspect, in an optional implementation, the sparsing is a manner of representing an original face image feature by using a linear combination of column vectors selected from a dictionary, and a manner of selecting a column vector is the 2-norm constraint. In this manner, in a solving process, the 2-norm constraint is used to loosen a limitation on sparsing, so that an analytical solution exists for formula calculation, a problem of a relatively long operation time caused by a plurality of iterative solving processes is avoided, and a dictionary obtaining speed is further increased.

With reference to the first aspect, in an optional implementation, the performing of facial recognition on the first face image based on the first sparse facial feature and the second sparse facial feature includes: calculating a similarity between the first sparse facial feature and the second sparse facial feature; and if the similarity is greater than a similarity threshold, determining that a facial recognition result is success; or if the similarity is less than or equal to the similarity threshold, determining that the facial recognition result of the first face image is failure.

According to a second aspect, an embodiment provides a facial recognition device. The device includes an obtaining unit, a determining unit, a mapping unit, and a recognition unit. The obtaining unit is configured to obtain a first face image and a second face image, where the first face image is a current face image obtained by a camera, and the second face image is a stored reference face image. The determining unit is configured to determine whether a modality of the first face image is the same as a modality of the second face image. The mapping unit is configured to: if the modality of the first face image is different from the modality of the second face image, separately map the first face image and the second face image to a cross-modal space, to obtain a first sparse facial feature of the first face image in the cross-modal space and a second sparse facial feature of the second face image in the cross-modal space, where the cross-modal space is a color space in which both the feature of the first face image and the feature of the second face image may be represented. The recognition unit is configured to perform facial recognition on the first face image based on the first sparse facial feature and the second sparse facial feature.

According to this device, the first face image and the second face image in different modalities may be mapped to the same cross-modal space by using a sparse representation method, and then facial recognition is performed on the first face image based on the first sparse facial feature obtained by mapping the first face image and the second sparse facial feature of the second face image. This facial recognition device does not depend on acceleration of a GPU, reducing a requirement on a hardware device, increasing a facial recognition speed, and meeting a real-time requirement on facial recognition. In addition, the sparse representation method has a relatively low requirement on a data volume, so that an overfitting problem can be avoided.

With reference to the second aspect, in an optional implementation, the mapping unit includes an obtaining subunit, a first mapping subunit, and a second mapping subunit. The obtaining subunit is configured to obtain a first dictionary corresponding to the modality of the first face image and a second dictionary corresponding to the modality of the second face image. The first mapping subunit is configured to map the first face image to the cross-modal space based on the first dictionary corresponding to the modality of the first face image, to obtain the first sparse facial feature of the first face image in the cross-modal space. The second mapping subunit is configured to map the second face image to the cross-modal space based on the second dictionary corresponding to the modality of the second face image, to obtain the second sparse facial feature of the second face image in the cross-modal space.

With reference to the second aspect, in an optional implementation, the obtaining subunit is configured to: obtain a feature representation matrix of the face image sample in the cross-modal space based on the first facial feature, the second facial feature, and an initialization dictionary by using an MP algorithm, where the first facial feature is a facial feature of the face image sample in the modality of the first face image, and the second facial feature is a facial feature of the face image sample in the modality of the second face image; and determine, based on the first facial feature, the second facial feature, and the feature representation matrix by using an MOD algorithm, the first dictionary corresponding to the modality of the first face image and the second dictionary corresponding to the modality of the second face image. According to this device, the first dictionary corresponding to the modality of the first face image and the second dictionary corresponding to the modality of the second face image may be determined at the same time, so that a facial recognition speed is increased.

With reference to the second aspect, in an optional implementation, the obtaining subunit is configured to solve a formula \hat{x}ᵢ=argₓ^{min}∥yᵢ−D₍₀₎x∥₂² subject to ∥x∥ₙ≤K by using the MP algorithm, to obtain the feature representation matrix of the face image sample in the cross-modal space, where 1<i<M, yᵢ is an i^{th} column vector in a matrix Y including the first facial feature and the second facial feature, the first row vector to an M^{th} row vector in the matrix Y are the first facial feature, an (M+1)^{th} row vector to a (2M)^{th} row vector are the second facial feature, \hat{x}ᵢ is an i^{th} column vector in the feature representation matrix in the cross-modal space, D₍₀₎ is the initialization dictionary, n represents a constraint manner of sparsing, and K is sparsity.

With reference to the second aspect, in an optional implementation, the obtaining subunit is configured to solve a formula D=arg_{X}^{min}∥Y−DX∥_{F}²=YX^{T}(XX^{T})⁻¹ by using the MOD algorithm, to obtain the first dictionary corresponding to the modality of the first face image and the second dictionary corresponding to the modality of the second face image, where D is a matrix including the first dictionary corresponding to the modality of the first face image and the second dictionary corresponding to the modality of the second face image, and X is the feature representation matrix.

With reference to the second aspect, in an optional implementation, D includes M column vectors and 2M row vectors, a matrix including the first row vector to an M^{th} row vector is the first dictionary corresponding to the modality of the first face image, and a matrix including an (M+1)^{th} row vector to a (2M)^{th} row vector is the second dictionary corresponding to the modality of the second face image.

With reference to the second aspect, in an optional implementation, the first mapping subunit is configured to: determine, based on the first dictionary corresponding to the modality of the first face image and a penalty coefficient, a first projection matrix corresponding to the modality of the first face image; and calculate the first sparse facial feature of the first face image in the cross-modal space by using the first projection matrix corresponding to the modality of the first face image and the first face image.

With reference to the second aspect, in an optional implementation, the second mapping subunit is configured to: determine, based on the second dictionary corresponding to the modality of the second face image and the penalty coefficient, a second projection matrix corresponding to the modality of the second face image; and calculate the second sparse facial feature of the second face image in the cross-modal space by using the second projection matrix corresponding to the modality of the second face image and the second face image.

With reference to the second aspect, in an optional implementation, the determining unit is configured to: separately transform the first face image and the second face image from a red-green-blue RGB color space to a YCbCr space of a luma component, a blue-difference chroma component, and a red-difference chroma component; determine a color coefficient value of the first face image and a color coefficient value of the second face image based on a value of the first face image in the YCbCr space and a value of the second face image in the YCbCr space; and determine, based on the color coefficient value of the first face image and the color coefficient value of the second face image, whether the modality of the first face image is the same as the modality of the second face image.

With reference to the second aspect, in an optional implementation, that the modality of the first face image is different from the modality of the second face image means that one of the color coefficient value of the first face image and the color coefficient value of the second face image is greater than a first threshold, and the other color coefficient value is not greater than the first threshold.

With reference to the second aspect, in an optional implementation, the sparsing is a manner of representing an original face image feature by using a linear combination of column vectors selected from a dictionary, and a manner of selecting a column vector is one of 0-norm constraint, 1-norm constraint, and 2-norm constraint.

With reference to the second aspect, in an optional implementation, the sparsing is a manner of representing an original face image feature by using a linear combination of column vectors selected from a dictionary, and a manner of selecting a column vector is the 2-norm constraint. In this manner, in a solving process, the 2-norm constraint is used to loosen a limitation on sparsing, so that an analytical solution exists for formula calculation, a problem of a relatively long operation time caused by a plurality of iterative solving processes is avoided, and a dictionary obtaining speed is further increased.

With reference to the second aspect, in an optional implementation, the recognition unit is configured to: calculate a similarity between the first sparse facial feature and the second sparse facial feature; and if the similarity is greater than a similarity threshold, determine that a facial recognition result is success; or if the similarity is less than or equal to the similarity threshold, determine that the facial recognition result of the first face image is failure.

According to a third aspect, an embodiment provides another device, including a processor and a memory. The processor and the memory are connected to each other, the memory is configured to store program instructions, and the processor is configured to invoke the program instructions in the memory to perform the method described in any one of the first aspect and the possible implementations of the first aspect.

According to a fourth aspect, an embodiment provides a computer-readable storage medium. The computer storage medium stores program instructions, and when the program instructions are run on a processor, the processor performs the method described in any one of the first aspect and the possible implementations of the first aspect.

According to a fifth aspect, an embodiment provides a computer program. When the computer program runs on a processor, the processor performs the method described in any one of the first aspect and the possible implementations of the first aspect.

According to the embodiments, the first face image and the second face image in different modalities may be mapped to the same cross-modal space by using the sparse representation method, and then facial recognition is performed on the first face image based on the first sparse facial feature obtained by mapping the first face image and the second sparse facial feature of the second face image. This facial recognition manner does not depend on acceleration of a GPU, reducing a requirement on a hardware device, increasing a facial recognition speed, and meeting a real-time requirement on facial recognition. In addition, the sparse representation method has a relatively low requirement on a data volume, so that an overfitting problem can be avoided.

### BRIEF DESCRIPTION OF DRAWINGS

To describe the solutions in the embodiments more clearly, the following briefly describes the accompanying drawings for describing the embodiments.

FIG. 1 is a schematic architectural diagram of a facial recognition system according to an embodiment;

FIG. 2 is a schematic diagram of obtaining a face image according to an embodiment;

FIG. 3 is another schematic diagram of obtaining a face image according to an embodiment;

FIG. 4 is a flowchart of a facial recognition method according to an embodiment;

FIG. 5 is a flowchart of another facial recognition method according to an embodiment;

FIG. 6 is a schematic diagram of a facial recognition device according to an embodiment; and

FIG. 7 is a schematic diagram of another facial recognition device according to an embodiment.

### DETAILED DESCRIPTION OF THE EMBODIMENTS

The following describes the solutions in the embodiments in detail.

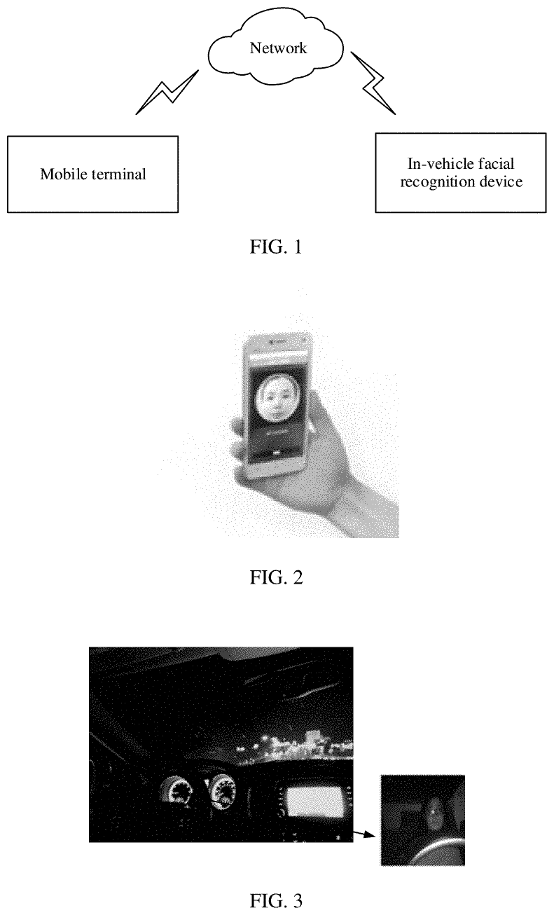

FIG. 1 is a schematic architectural diagram of a facial recognition system according to an embodiment. The system includes a mobile terminal and an in-vehicle facial recognition device, and the mobile terminal may communicate with the facial recognition device by using a network. For example, a visible light camera is usually disposed on the mobile terminal and may obtain a face image of a user in a visible light modality. FIG. 2 is a schematic diagram of obtaining a face image according to an embodiment. The obtained face image is a face image in the visible light modality, and the user may use the face image to perform identity enrollment and identity authentication. The mobile terminal may send the face image to the in-vehicle facial recognition device by using the network for storage. Correspondingly, the in-vehicle facial recognition device may receive, by using the network, the face image sent by the mobile terminal.

A near-infrared camera is disposed on the in-vehicle facial recognition device and is configured to collect a face image of the user in a frequently occurring in-vehicle scenario of poor lighting in a garage or at night, for example. The face image obtained by the in-vehicle facial recognition system is a face image in a near-infrared modality. FIG. 3 is another schematic diagram of obtaining a face image according to an embodiment. The face image obtained by the in-vehicle facial recognition system is a face image in the near-infrared modality. The in-vehicle facial recognition device compares the obtained current face image of the user with a stored face image, to perform facial recognition. For example, facial recognition may be used to verify whether the current user succeeds in identity authentication, to improve vehicle security; and facial recognition may also be used to determine an identity of the user, to perform a personalized service (for example, adjusting a seat, playing music in a dedicated music library, or enabling vehicle application permission) corresponding to the identity of the user.

In an optional implementation, the system may further include a decision device, and the decision device is configured to perform a corresponding operation based on a facial recognition result of the in-vehicle facial recognition device. For example, an operation such as starting a vehicle or starting an in-vehicle air conditioner may be performed based on a result that verification succeeds in facial recognition. The personalized service (for example, adjusting a seat, playing music in a dedicated music library, or enabling in-vehicle application permission) corresponding to the identity of the user may be further performed based on the identity that is of the user and that is determined through facial recognition.

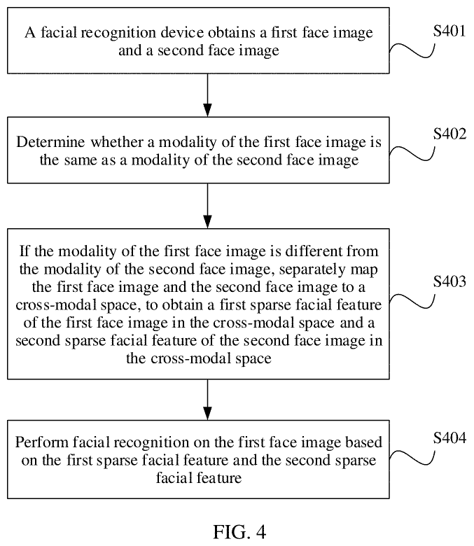

FIG. 4 is a flowchart of a facial recognition method according to an embodiment. The method may be implemented based on the architecture shown in FIG. 1. The following facial recognition device may be the in-vehicle facial recognition device in the system architecture shown in FIG. 1. The method includes, but is not limited to, the following.

S401. The facial recognition device obtains a first face image and a second face image.

For example, after a user enters a vehicle, the facial recognition device may collect the current first face image of the user by using a disposed near-infrared camera; or after the user triggers identity verification for a personalized service (for example, adjusting a seat, playing music in a dedicated music library, or enabling in-vehicle application permission), the facial recognition device may collect the current first face image of the user by using the disposed near-infrared camera.

The second face image is a stored reference face image. The second face image may be a face image that is previously photographed and stored by the facial recognition device, a face image that is received by the facial recognition device and that is sent and stored by another device (for example, a mobile terminal), a face image that is read from another storage medium and stored by the facial recognition device, or the like. The second face image may have a correspondence with an identity of a character, and the second face image may also have a correspondence with the personalized service.

S402. Determine whether a modality of the first face image is the same as a modality of the second face image.

For example, that the modality of the first face image is different from the modality of the second face image means that one of a color coefficient value of the first face image and a color coefficient value of the second face image is greater than a first threshold, and the other color coefficient value is not greater than the first threshold.

S403. If the modality of the first face image is different from the modality of the second face image, separately map the first face image and the second face image to a cross-modal space, to obtain a first sparse facial feature of the first face image in the cross-modal space and a second sparse facial feature of the second face image in the cross-modal space.

The cross-modal space is a color space in which both the feature of the first face image and the feature of the second face image may be represented. Conventionally, when the modality of the first face image is different from the modality of the second face image, the first face image and second face image are usually directly recognized by using a convolutional neural network. In this manner, acceleration of a graphical processing unit (GPU) is required, and calculation is slow on a device without a GPU. Consequently, a real-time requirement cannot be met. In addition, a parameter of the convolutional neural network needs to be constantly adjusted, and a large quantity of training samples are required. Therefore, overfitting of the network tends to occur. In this embodiment, the first face image and the second face image are separately mapped to the cross-modal space, and the first sparse facial feature and the second sparse facial feature that are obtained through mapping are compared, to perform facial recognition. This manner depends on neither the convolutional neural network nor the acceleration of a GPU, increasing a facial recognition speed, and meeting a real-time requirement on facial recognition. In addition, a sparse representation method has a relatively low requirement on a data volume, so that an overfitting problem can be avoided.

S404. Perform facial recognition on the first face image based on the first sparse facial feature and the second sparse facial feature.

Optionally, the performing of facial recognition on the first face image based on the first sparse facial feature and the second sparse facial feature includes: calculating a similarity between the first sparse facial feature and the second sparse facial feature; and if the similarity is greater than a similarity threshold, determining that a facial recognition result is success; or if the similarity is less than or equal to the similarity threshold, determining that the facial recognition result of the first face image is failure. The similarity threshold may be calibrated through an experiment.

It should be noted that when the modality of the first face image is different from the modality of the second face image, the foregoing manner may be used as a reference to map the face images in different modalities to the cross-modal space and then compare the sparse facial features obtained through mapping, to obtain the facial recognition result. For example, the modality of the first face image may be a near-infrared modality, and the modality of the second face image may be a visible light modality; the modality of the first face image may be a two-dimensional (2D) modality, and the modality of the second face image may be a three-dimensional (3D) modality; the modality of the first face image may be a low-precision modality, and the modality of the second face image may be a high-precision modality; or the like. The modality of the first face image and the modality of the second face image are not limited.

According to the method shown in FIG. 4, the first face image and the second face image in different modalities may be mapped to the same cross-modal space by using the sparse representation method, and then facial recognition is performed on the first face image based on the first sparse facial feature obtained by mapping the first face image and the second sparse facial feature of the second face image. This facial recognition manner does not depend on acceleration of a GPU, reducing a requirement on a hardware device, increasing a facial recognition speed, and meeting a real-time requirement on facial recognition. In addition, the sparse representation method has a relatively low requirement on a data volume, so that an overfitting problem can be avoided.

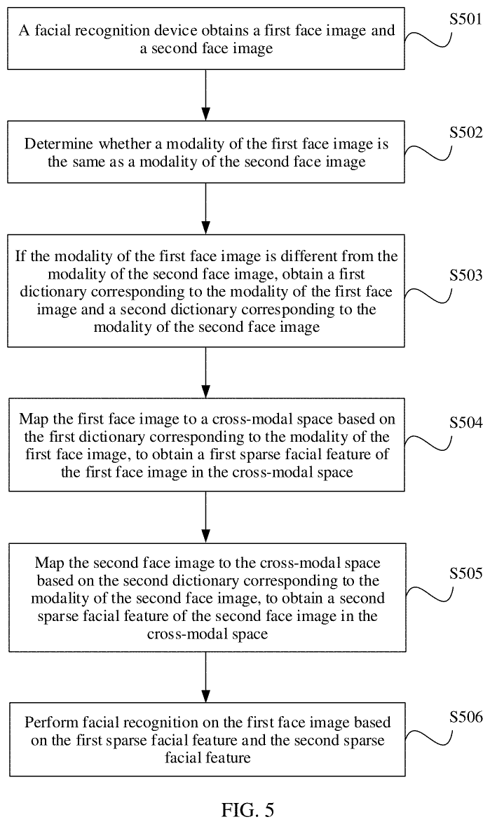

FIG. 5 is a flowchart of another facial recognition method according to an embodiment. The method may be implemented based on the architecture shown in FIG. 1. The following facial recognition device may be the in-vehicle facial recognition device in the system architecture shown in FIG. 1. The method includes, but is not limited to, the following.

S501. The facial recognition device obtains a first face image and a second face image.

For example, after a user enters a vehicle, the facial recognition device may collect the current first face image of the user by using a disposed near-infrared camera; or after the user triggers identity verification for a personalized service (for example, adjusting a seat, playing music in a dedicated music library, or enabling in-vehicle application permission), the facial recognition device may collect the current first face image of the user by using the disposed near-infrared camera.

The second face image is a stored reference face image. The second face image may be a face image that is previously photographed and stored by the facial recognition device, a face image that is received by the facial recognition device and that is sent and stored by another device (for example, a mobile terminal), a face image that is read from another storage medium and stored by the facial recognition device, or the like. The second face image may have a correspondence with an identity of a character, and the second face image may also have a correspondence with the personalized service.

Optionally, after obtaining the first face image and the second face image, the facial recognition device preprocesses the first face image and the second face image. The preprocessing includes size adjustment processing and standardization processing. Through the preprocessing, face image data obtained through processing conforms to a standard normal distribution, in other words, a mean is 0, and a standard deviation is 1. A standardization processing manner may be shown in Formula 1-1:

x=(x−μ)/δ Formula 1-1

In Formula 1-1, μ is a mean corresponding to a modality of a face image, δ is a standard deviation corresponding to the modality of the face image, and values of μ and δ corresponding to different modalities are different. For example, if the first face image is preprocessed, μ in Formula 1-1 is a mean corresponding to a modality of the first face image, and δ in Formula 1-1 is a standard deviation corresponding to the modality of the first face image. The mean corresponding to the modality of the first face image and the standard deviation corresponding to the modality of the first face image may be calibrated through an experiment, and the mean corresponding to the modality of the first face image and the standard deviation corresponding to the modality of the first face image may be obtained by performing calculation processing on a plurality of face image samples in modalities of a plurality of first face images. A mean corresponding to a modality of the second face image and a standard deviation corresponding to the modality of the second face image may be obtained according to a same manner. Details are not described herein again.

S502. Determine whether the modality of the first face image is the same as the modality of the second face image.

For example, an implementation of determining whether the modality of the first face image is the same as the modality of the second face image is as follows:

(1) Separately transform the first face image and the second face image from a red-green-blue RGB color space to a YCbCr space of a luma component, a blue-difference chroma component, and a red-difference chroma component.

For example, a manner of transforming a face image from the red-green-blue RGB color space to the YCbCr space of the luma component, the blue-difference chroma component, and the red-difference chroma component may be shown in the following Formula 1-2:

$$[ \begin{matrix}Y \\ {C}_{b} \\ {C}_{r}\end{matrix} ] = [ \begin{matrix}16 \\ 128 \\ 128\end{matrix} ] + \frac{1}{256} \times [ \begin{matrix}65.738 & 129.057 & 25.064 \\ - 37.945 & - 74.494 & 112.439 \\ 112.439 & - 94.154 & - 18.285\end{matrix} ] \times [ \begin{matrix}R \\ G \\ B\end{matrix} ] \qquad Formula 1 - 2$$

In Formula 1-2, R represents a value of a red channel of a pixel in the face image, G represents a value of a green channel of the pixel, B represents a value of a blue channel of the pixel, Y represents a luma component value of the pixel, C_{b} represents a blue-difference chroma component value of the pixel, and Cᵣ represents a red-difference chroma component value of the pixel.

(2) Determine a color coefficient value of the first face image and a color coefficient value of the second face image based on a value of the first face image in the YCbCr space and a value of the second face image in the YCbCr space.

For example, a manner of calculating a color coefficient value of a face image may be shown in Formula 1-3:

$$y = \frac{1}{2 n} ( {\sum }_{i = 1}^{n} ( {e}^{\frac{1}{256} {c}_{b i}} - 1 ) + {\sum }_{i = 1}^{n} ( {e}^{\frac{1}{256} {c}_{ri}} - 1 ) ) \qquad Formula 1 - 3$$

In Formula 1-3, y represents the color coefficient value of the face image, which can represent a modal feature of the face image, n represents a quantity of pixels in the face image, and cᵣᵢ is a red-difference chroma component value of an i^{th} pixel in the face image, and c_{bi} is a blue-difference chroma component value of an i^{th} pixel in the face image.

(3) Determine, based on the color coefficient value of the first face image and the color coefficient value of the second face image, whether the modality of the first face image is the same as the modality of the second face image.

For example, that the modality of the first face image is different from the modality of the second face image means that one of the color coefficient value of the first face image and the color coefficient value of the second face image is greater than a first threshold, and the other color coefficient value is not greater than the first threshold.

If a color coefficient value of a face image is greater than the first threshold, the face image is an image in a visible light modality. If a color coefficient value of a face image is not greater than the first threshold, the face image is an image in a near-infrared modality. The first threshold is a value calibrated in an experiment. For example, the first threshold may be 0.5.

S503. If the modality of the first face image is different from the modality of the second face image, obtain a first dictionary corresponding to the modality of the first face image and a second dictionary corresponding to the modality of the second face image.

A sparse representation method for representing a feature of a face image is first described. Sparsing is a manner of representing an original face image feature by using a linear combination of column vectors selected from a dictionary, and a manner of selecting a column vector is one of 0-norm constraint, 1-norm constraint, and 2-norm constraint.

The following describes a method for obtaining the first dictionary corresponding to the modality of the first face image and the second dictionary corresponding to the modality of the second face image. The method includes, but is not limited to, the following.

(1) Construct a cross-modal initialization dictionary D(0).

A value in the initialization dictionary D(0) may be a randomly generated value or may be a value generated based on a sample randomly selected from a face image sample. After the cross-modal initialization dictionary is constructed, columns of the cross-modal initialization dictionary D(0) are normalized. Thus, the face image sample includes a plurality of samples.

(2) Assume that k=0, and cyclically perform a procedure A until Y−D₍ₖ₎X_{(K)} is less than a second threshold. In this case, D₍ₖ₎ is D.

Y is a feature representation matrix of the face image sample. In other words,

$$Y = [ \begin{matrix}{Y}_{V} \\ {Y}_{N}\end{matrix} ] ,$$

where Y_{V} is a facial feature of the face image sample in the modality of the first face image, and Y_{N} is a facial feature of the face image sample in the modality of the second face image. The first row vector to an M^{th} row vector in Y are the first facial feature Y_{V}, and an (M+1)^{th} row vector to a (2M)^{th} row vector are the second facial feature Y_{N}. For example, one column vector in Y_{V} represents a feature of one sample in the modality of the first face image, and one column vector in Y_{N} represents a feature of one sample in the modality of the second face image.

D is a matrix including the first dictionary corresponding to the modality of the first face image and the second dictionary corresponding to the modality of the second face image. In other words,

$$D = [ \begin{matrix}{D}_{V} \\ {D}_{N}\end{matrix} ] ,$$

where Dᵥ is the first dictionary corresponding to the modality of the first face image, and D_{N} is the second dictionary corresponding to the modality of the second face image. D includes M column vectors and 2M row vectors, a matrix including the first row vector to an M^{th} row vector is the first dictionary corresponding to the modality of the first face image, and a matrix including an (M+1)^{th} row vector to a (2M)^{th} row vector is the second dictionary corresponding to the modality of the second face image. X₍ₖ₎ is a feature representation matrix of the face image sample in the cross-modal space.

D₍ₖ₎X_{(K)} represents a sparse facial feature obtained by mapping the face image sample to the cross-modal space, Y−D₍ₖ₎X_{(K)} represents a difference between a feature of the face image sample and the sparse facial feature obtained by mapping the face image sample to the cross-modal space, and a smaller difference indicates better performance of the first dictionary and the second dictionary.

For example, the procedure A is as follows:

1. k=k+1.

2. Obtain the feature representation matrix of the face image sample in the cross-modal space based on the first facial feature, the second facial feature, and the initialization dictionary by using a matching pursuit (MP) algorithm, where the first facial feature is a facial feature of the face image sample in the modality of the first face image, and the second facial feature is a facial feature of the face image sample in the modality of the second face image.

Further, the following Formula 1-4 may be solved by using the MP algorithm to obtain the feature representation matrix X₍ₖ₎ of the face image sample in the cross-modal space. Formula 1-4 is:

\hat{x}ᵢ=argₓ^{min}∥yᵢ−D₍ₖ₋₁₎x∥₂² subject to ∥x∥ₙ≤K, 1≤i≤M Formula 1-4

In Formula 1-4, yᵢ is an i^{th} column vector in the feature representation matrix Y of the face image sample, and the feature representation matrix Y of the face image sample includes a total of M column vectors. For example, the feature representation matrix X₍ₖ₎ of the face image sample in the cross-modal space includes \hat{x}ᵢ, where 1<i<M. K is sparsity, and D₍ₖ₋₁₎ is a matrix that is obtained after the (k-1)^{th} update and that includes the first dictionary corresponding to the modality of the first face image and the second dictionary corresponding to the modality of the second face image.

Further, in the embodiment, n represents a constraint manner of sparsing, and a value of n is one of 0, 1, and 2. Additionally, when the value of n is 0, the constraint manner of sparsing is the 0-norm constraint, and ∥x∥₀≤K indicates that a quantity of elements that are not 0 in x is less than or equal to the sparsity K. When the value of n is 1, the constraint manner of sparsing is the 1-norm constraint, and ∥x∥₁≤K indicates that a sum of absolute values of elements in x is less than or equal to the sparsity K. When the value of n is 2, the constraint manner of sparsing is the 2-norm constraint, and ∥x∥₂≤K indicates that a sum of squares of elements in x is less than or equal to the sparsity K. Further, using the solving manner of the 2-norm constraint to find a sparse facial feature of a face image can loosen a limitation on sparsing, so that an analytical solution exists for formula calculation, a problem of a relatively long operation time caused by a plurality of iterative solving processes is avoided, and a dictionary obtaining speed is further increased.

3. Determine, based on the facial feature of the face image sample in the modality of the first face image, the facial feature of the face image sample in the modality of the second face image, and the feature representation matrix by using a method of optimal directions (MOD) algorithm, the first dictionary corresponding to the modality of the first face image and the second dictionary corresponding to the modality of the second face image.

For example, the first dictionary corresponding to the modality of the first face image and the second dictionary corresponding to the modality of the second face image may be determined according to Formula 1-5. Formula 1-5 is:

D₍ₖ₎arg_{X}^{min}=∥Y−DX₍ₖ₋₁₎∥_{F}²=YX_{(K)}^{T}(X_{(K)}X_{(K)}^{T})⁻¹ Formula 1-5

In Formula 1-5, F is a matrix norm, and X₍ₖ₋₁₎ is a feature representation matrix, in the cross-modal space, obtained after the (k-1)^{th} update. D₍ₖ₎ is a matrix that is obtained after the k^{th} update and that includes the first dictionary corresponding to the modality of the first face image and the second dictionary corresponding to the modality of the second face image.

According to the foregoing method, the first dictionary corresponding to the modality of the first face image and the second dictionary corresponding to the modality of the second face image may be obtained at the same time, thereby reducing an operation time and increasing a dictionary obtaining speed. In addition, in a solving process, the 2-norm constraint may be used to loosen a limitation on sparsing, so that an analytical solution exists for formula calculation, a problem of a relatively long operation time caused by a plurality of iterative solving processes is avoided, and a dictionary obtaining speed is further increased

S504. Map the first face image to the cross-modal space based on the first dictionary corresponding to the modality of the first face image, to obtain a first sparse facial feature of the first face image in the cross-modal space.

For example, a manner of mapping the first face image to the cross-modal space based on the first dictionary corresponding to the modality of the first face image, to obtain the first sparse facial feature of the first face image in the cross-modal space is: determining, based on the first dictionary corresponding to the modality of the first face image and a penalty coefficient, a cross-modal projection matrix corresponding to the modality of the first face image; and calculating the first sparse facial feature of the first face image in the cross-modal space by using the cross-modal projection matrix corresponding to the modality of the first face image and the first face image.

A calculation manner of determining, based on the first dictionary corresponding to the modality of the first face image and the penalty coefficient, the cross-modal projection matrix corresponding to the modality of the first face image may be shown in Formula 1-6:

Pₐ=(λ.I+D_{V}^{T}D_{V})⁻¹D_{V}^{T} Formula 1-6

In Formula 1-6, D_{V} is the first dictionary corresponding to the modality of the first face image, Pₐ is the cross-modal projection matrix corresponding to the modality of the first face image, λ is the penalty coefficient, is related to the sparsity, and may be calibrated through an experiment, and I is an identity matrix.

Thus, a calculation manner of calculating the first sparse facial feature of the first face image in the cross-modal space by using the cross-modal projection matrix corresponding to the modality of the first face image and the first face image may be shown in Formula1-7:

Aᵢ=PₐYₐᵢ, 1<i<M Formula 1-7

In Formula 1-7, Aᵢ is the first sparse facial feature of the first face image in the cross-modal space, yₐᵢ is the i^{th} column vector in a feature representation matrix of the first face image, and Pₐ is the cross-modal projection matrix corresponding to the modality of the first face image.

S505. Map the second face image to the cross-modal space based on the second dictionary corresponding to the modality of the second face image, to obtain a second sparse facial feature of the second face image in the cross-modal space.

For example, a manner of mapping the second face image to the cross-modal space based on the second dictionary corresponding to the modality of the second face image, to obtain the second sparse facial feature of the second face image in the cross-modal space is: determining, based on the second dictionary corresponding to the modality of the second face image and the penalty coefficient, a cross-modal projection matrix corresponding to the modality of the second face image; and calculating the second sparse facial feature of the second face image in the cross-modal space by using the cross-modal projection matrix corresponding to the modality of the second face image and the second face image.

A calculation manner of determining, based on the second dictionary corresponding to the modality of the second face image and the penalty coefficient, the cross-modal projection matrix corresponding to the modality of the second face image may be shown in Formula 1-8:

P_{b}=(λ.I+D_{N}^{T}D_{N})⁻¹D_{N}^{T} Formula 1-8

In Formula 1-8, D_{N} is the second dictionary corresponding to the modality of the second face image, P_{b} is the cross-modal projection matrix corresponding to the modality of the first face image, λ is the penalty coefficient, is related to the sparsity, and may be calibrated through an experiment, and I is an identity matrix.

For example, a calculation manner of calculating the second sparse facial feature of the second face image in the cross-modal space by using the cross-modal projection matrix corresponding to the modality of the second face image and the second face image may be shown in Formula 1-9:

Bᵢ=P_{b}y_{bi}, 1<i<M Formula 1-9

In Formula1-9, Bᵢ is the second sparse facial feature of the second face image in the cross-modal space, y_{bi} is an i^{th} column vector in a feature representation matrix of the second face image, and P_{b} is the cross-modal projection matrix corresponding to the modality of the second face image.

S506. Perform facial recognition on the first face image based on the first sparse facial feature and the second sparse facial feature.

For example, the performing facial recognition on the first face image based on the first sparse facial feature and the second sparse facial feature includes: calculating a similarity between the first sparse facial feature and the second sparse facial feature; and if the similarity is greater than a similarity threshold, determining that a facial recognition result is success; or if the similarity is less than or equal to the similarity threshold, determining that the facial recognition result of the first face image is failure. The similarity threshold may be calibrated through an experiment.

Optionally, a manner of calculating the similarity between the first sparse facial feature and the second sparse facial feature may be calculating a cosine distance between the first sparse facial feature and the second sparse facial feature. A manner of calculating the cosine distance between the first sparse facial feature and the second sparse facial feature may be shown in Formula 1-10:

$$cos θ = \frac{{\sum }_{1}^{n} ( {A}_{i} * {B}_{i} )}{\sqrt{{\sum }_{1}^{n} {A}_{i}^{2}} * \sqrt{{\sum }_{1}^{n} {B}_{i}^{2}}} , 1 < i < M \qquad Formula 1 - 10$$

In Formula 1-10, Aᵢ is the first sparse facial feature of the first face image in the cross-modal space, Bᵢ is the second sparse facial feature of the second face image in the cross-modal space, and n represents a dimension of a sparse feature. It should be noted that the similarity between the first sparse facial feature and the second sparse facial feature may be calculated in another manner, and this is not limited herein.

According to the method shown in FIG. 5, the first face image and the second face image in different modalities may be mapped to the same cross-modal space by using the sparse representation method, and then facial recognition is performed on the first face image based on the first sparse facial feature obtained by mapping the first face image and the second sparse facial feature of the second face image. This facial recognition manner does not depend on acceleration of a GPU, reducing a requirement on a hardware device, increasing a facial recognition speed, and meeting a real-time requirement on facial recognition. In addition, the sparse representation method has a relatively low requirement on a data volume, so that an overfitting problem can be avoided.

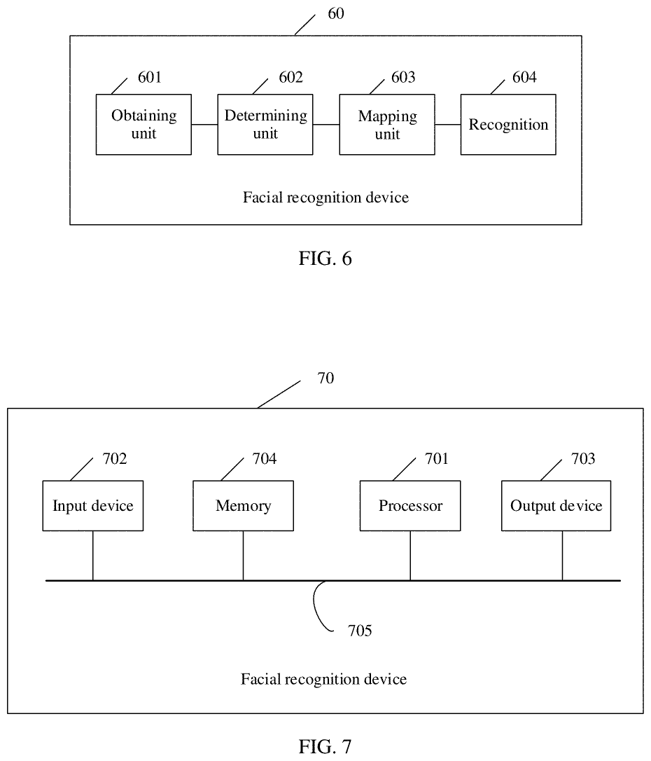

FIG. 6 is a schematic diagram of a facial recognition device according to an embodiment. The facial recognition device 60 includes an obtaining unit 601, a determining unit 602, a mapping unit 603, and a recognition unit 604. The following describes these units.

The obtaining unit 601 is configured to obtain a first face image and a second face image. The first face image is a current face image obtained by a camera, and the second face image is a stored reference face image.

The determining unit 602 is configured to determine whether a modality of the first face image is the same as a modality of the second face image.

The mapping unit 603 is configured to: when the modality of the first face image is different from the modality of the second face image, separately map the first face image and the second face image to a cross-modal space, to obtain a first sparse facial feature of the first face image in the cross-modal space and a second sparse facial feature of the second face image in the cross-modal space. The cross-modal space is a color space in which both the feature of the first face image and the feature of the second face image may be represented.

The recognition unit 604 is configured to perform facial recognition on the first face image based on the first sparse facial feature and the second sparse facial feature.

According to this device, the first face image and the second face image in different modalities may be mapped to the same cross-modal space by using a sparse representation method, and then facial recognition is performed on the first face image based on the first sparse facial feature obtained by mapping the first face image and the second sparse facial feature of the second face image. This facial recognition device does not depend on acceleration of a GPU, reducing a requirement on a hardware device, increasing a facial recognition speed, and meeting a real-time requirement on facial recognition. In addition, the sparse representation method has a relatively low requirement on a data volume, so that an overfitting problem can be avoided.

In an optional implementation, the mapping unit includes an obtaining subunit, a first mapping subunit, and a second mapping subunit. The obtaining subunit is configured to obtain a first dictionary corresponding to the modality of the first face image and a second dictionary corresponding to the modality of the second face image. The first mapping subunit is configured to map the first face image to the cross-modal space based on the first dictionary corresponding to the modality of the first face image, to obtain the first sparse facial feature of the first face image in the cross-modal space. The second mapping subunit is configured to map the second face image to the cross-modal space based on the second dictionary corresponding to the modality of the second face image, to obtain the second sparse facial feature of the second face image in the cross-modal space.

In an optional implementation, the obtaining subunit is configured to: obtain a feature representation matrix of the face image sample in the cross-modal space based on the first facial feature, the second facial feature, and an initialization dictionary by using an MP algorithm, where the first facial feature is a facial feature of the face image sample in the modality of the first face image, and the second facial feature is a facial feature of the face image sample in the modality of the second face image; and determine, based on the first facial feature, the second facial feature, and the feature representation matrix by using an MOD algorithm, the first dictionary corresponding to the modality of the first face image and the second dictionary corresponding to the modality of the second face image. According to this device, the first dictionary corresponding to the modality of the first face image and the second dictionary corresponding to the modality of the second face image may be determined at the same time, so that a facial recognition speed is increased.

In an optional implementation, the obtaining subunit is configured to solve a formula \hat{x}ᵢ=argₓ^{min}∥yᵢ-D₍ₒ₎x∥₂² subject to ∥x∥ₙ≤K by using the MP algorithm, to obtain the feature representation matrix of the face image sample in the cross-modal space, where 1<i<M, yᵢ is an i^{th} column vector in a matrix Y including the first facial feature and the second facial feature, the first row vector to an M^{th} row vector in the matrix Y are the first facial feature, an (M+1)^{th} row vector to a (2M)^{th} row vector are the second facial feature, \hat{x}ᵢ is an i^{th} column vector in the feature representation matrix in the cross-modal space, D₍₀₎ is the initialization dictionary, n represents a constraint manner of sparsing, and K is sparsity.

In an optional implementation, the obtaining subunit is configured to solve a formula D=arg_{X}^{min}∥Y-DX∥_{F}²=YX^{T}(X X^{T})⁻¹ by using the MOD algorithm, to obtain the first dictionary corresponding to the modality of the first face image and the second dictionary corresponding to the modality of the second face image, where D is a matrix including the first dictionary corresponding to the modality of the first face image and the second dictionary corresponding to the modality of the second face image, and X is the feature representation matrix.

In an optional implementation, D includes M column vectors and 2M row vectors, a matrix including the first row vector to an M^{th} row vector is the first dictionary corresponding to the modality of the first face image, and a matrix including an (M+1)^{th} row vector to a (2M)^{th} row vector is the second dictionary corresponding to the modality of the second face image.

In an optional implementation, the first mapping subunit is configured to: determine, based on the first dictionary corresponding to the modality of the first face image and a penalty coefficient, a first projection matrix corresponding to the modality of the first face image; and calculate the first sparse facial feature of the first face image in the cross-modal space by using the first projection matrix corresponding to the modality of the first face image and the first face image.

In an optional implementation, the second mapping subunit is configured to: determine, based on the second dictionary corresponding to the modality of the second face image and the penalty coefficient, a second projection matrix corresponding to the modality of the second face image; and calculate the second sparse facial feature of the second face image in the cross-modal space by using the second projection matrix corresponding to the modality of the second face image and the second face image.

In an optional implementation, the determining unit is configured to: separately transform the first face image and the second face image from a red-green-blue RGB color space to a YCbCr space of a luma component, a blue-difference chroma component, and a red-difference chroma component; determine a color coefficient value of the first face image and a color coefficient value of the second face image based on a value of the first face image in the YCbCr space and a value of the second face image in the YCbCr space; and determine, based on the color coefficient value of the first face image and the color coefficient value of the second face image, whether the modality of the first face image is the same as the modality of the second face image.

In an optional implementation, that the modality of the first face image is different from the modality of the second face image means that one of the color coefficient value of the first face image and the color coefficient value of the second face image is greater than a first threshold, and the other color coefficient value is not greater than the first threshold.

In an optional implementation, the sparsing is a manner of representing an original face image feature by using a linear combination of column vectors selected from a dictionary, and a manner of selecting a column vector is one of 0-norm constraint, 1-norm constraint, and 2-norm constraint.

In an optional implementation, the sparsing is a manner of representing an original face image feature by using a linear combination of column vectors selected from a dictionary, and a manner of selecting a column vector is the 2-norm constraint. In this manner, in a solving process, the 2-norm constraint is used to loosen a limitation on sparsing, so that an analytical solution exists for formula calculation, a problem of a relatively long operation time caused by a plurality of iterative solving processes is avoided, and a dictionary obtaining speed is further increased.

In an optional implementation, the recognition unit is configured to: calculate a similarity between the first sparse facial feature and the second sparse facial feature; and if the similarity is greater than a similarity threshold, determine that a facial recognition result is success; or if the similarity is less than or equal to the similarity threshold, determine that the facial recognition result of the first face image is failure.

For implementation of each operation in FIG. 6, further correspondingly refer to the corresponding descriptions in the method embodiment shown in FIG. 4 or FIG. 5.

According to the facial recognition device shown in FIG. 6, the first face image and the second face image in different modalities may be mapped to the same cross-modal space by using the sparse representation method, and then facial recognition is performed on the first face image based on the first sparse facial feature obtained by mapping the first face image and the second sparse facial feature of the second face image. This facial recognition manner does not depend on acceleration of a GPU, reducing a requirement on a hardware device, increasing a facial recognition speed, and meeting a real-time requirement on facial recognition. In addition, the sparse representation method has a relatively low requirement on a data volume, so that an overfitting problem can be avoided.

FIG. 7 is a schematic diagram of another facial recognition device according to an embodiment. The first device 70 may include one or more processors 701, one or more input devices 702, one or more output devices 703, and a memory 704. The processor 701, the input device 702, the output device 703, and the memory 704 are connected by using a bus 705. The memory 704 is configured to store instructions.

The processor 701 may be a central processing unit, or the processor may be another general-purpose processor, a digital signal processor, an application-specific integrated circuit, another programmable logic device, or the like. The general purpose processor may be a microprocessor, or the processor may be any conventional processor or the like.

The input device 702 may include a communications interface, a data cable, and the like, and the output device 703 may include a display (for example, an LCD), a speaker, a data cable, a communications interface, and the like.

The memory 704 may include a read-only memory and a random access memory, and provide instructions and data to the processor 701. A part of the memory 704 may further include a non-volatile random access memory. For example, the memory 704 may further store information of a device type.

The processor 701 is configured to run the instructions stored in the memory 704 to perform the following operations:

obtaining a first face image and a second face image, where the first face image is a current face image obtained by a camera, and the second face image is a stored reference face image;

determining whether a modality of the first face image is the same as a modality of the second face image;

if the modality of the first face image is different from the modality of the second face image, separately mapping the first face image and the second face image to a cross-modal space, to obtain a first sparse facial feature of the first face image in the cross-modal space and a second sparse facial feature of the second face image in the cross-modal space, where the cross-modal space is a color space in which both the feature of the first face image and the feature of the second face image may be represented; and
performing facial recognition on the first face image based on the first sparse facial feature and the second sparse facial feature.

In an optional implementation, the processor 701 is configured to: obtain a first dictionary corresponding to the modality of the first face image and a second dictionary corresponding to the modality of the second face image; map the first face image to a cross-modal space based on the first dictionary corresponding to the modality of the first face image, to obtain a first sparse facial feature of the first face image in the cross-modal space; and map the second face image to the cross-modal space based on the second dictionary corresponding to the modality of the second face image, to obtain a second sparse facial feature of the second face image in the cross-modal space.

In an optional implementation, the processor 701 is configured to: obtain a feature representation matrix of the face image sample in the cross-modal space based on the first facial feature, the second facial feature, and an initialization dictionary by using an MP algorithm, where the first facial feature is a facial feature of the face image sample in the modality of the first face image, and the second facial feature is a facial feature of the face image sample in the modality of the second face image; and determine, based on the first facial feature, the second facial feature, and the feature representation matrix by using an MOD algorithm, the first dictionary corresponding to the modality of the first face image and the second dictionary corresponding to the modality of the second face image. According to this device, the first dictionary corresponding to the modality of the first face image and the second dictionary corresponding to the modality of the second face image may be determined at the same time, so that a facial recognition speed is increased.

In an optional implementation, the processor 701 is configured to solve a formula \hat{x}ᵢ=argₓ^{min}∥yᵢ-D₍₀₎x∥₂² subject to ∥x∥ₙ≤K by using the MP algorithm, to obtain the feature representation matrix of the face image sample in the cross-modal space, where 1<i<M, yᵢ is an i^{th} column vector in a matrix Y including the first facial feature and the second facial feature, the first row vector to an M^{th} row vector in the matrix Y are the first facial feature, an (M+1)^{th} row vector to a (2M)^{th} row vector are the second facial feature, \hat{x}ᵢ is ani^{th} column vector in the feature representation matrix in the cross-modal space, D₍₀₎ is the initialization dictionary, n represents a constraint manner of sparsing, and K is sparsity.

In an optional implementation, the processor 701 is configured to solve a formula D=arg_{X}^{min}∥Y-DX∥_{F}²=YX^{T}(XX^{T})⁻¹ by using the MOD algorithm, to obtain the first dictionary corresponding to the modality of the first face image and the second dictionary corresponding to the modality of the second face image, where D is a matrix including the first dictionary corresponding to the modality of the first face image and the second dictionary corresponding to the modality of the second face image, and X is the feature representation matrix.

In an optional implementation, D includes M column vectors and 2M row vectors, a matrix including the first row vector to an M^{th} row vector is the first dictionary corresponding to the modality of the first face image, and a matrix including an (M+1)^{th} row vector to a (2M)^{th} row vector is the second dictionary corresponding to the modality of the second face image.

In an optional implementation, the processor 701 is configured to: determine, based on the first dictionary corresponding to the modality of the first face image and a penalty coefficient, a first projection matrix corresponding to the modality of the first face image; and calculate the first sparse facial feature of the first face image in the cross-modal space by using the first projection matrix corresponding to the modality of the first face image and the first face image.

In an optional implementation, the processor 701 is configured to: determine, based on the second dictionary corresponding to the modality of the second face image and the penalty coefficient, a second projection matrix corresponding to the modality of the second face image; and calculate the second sparse facial feature of the second face image in the cross-modal space by using the second projection matrix corresponding to the modality of the second face image and the second face image.

In an optional implementation, the processor 701 is configured to: separately transform the first face image and the second face image from a red-green-blue RGB color space to a YCbCr space of a luma component, a blue-difference chroma component, and a red-difference chroma component; determine a color coefficient value of the first face image and a color coefficient value of the second face image based on a value of the first face image in the YCbCr space and a value of the second face image in the YCbCr space; and determine, based on the color coefficient value of the first face image and the color coefficient value of the second face image, whether the modality of the first face image is the same as the modality of the second face image.

In an optional implementation, that the modality of the first face image is different from the modality of the second face image means that one of the color coefficient value of the first face image and the color coefficient value of the second face image is greater than a first threshold, and the other color coefficient value is not greater than the first threshold.

In an optional implementation, the sparsing is a manner of representing an original face image feature by using a linear combination of column vectors selected from a dictionary, and a manner of selecting a column vector is one of 0-norm constraint, 1-norm constraint, and 2-norm constraint.

In an optional implementation, the sparsing is a manner of representing an original face image feature by using a linear combination of column vectors selected from a dictionary, and a manner of selecting a column vector is the 2-norm constraint. In this manner, in a solving process, the 2-norm constraint is used to loosen a limitation on sparsing, so that an analytical solution exists for formula calculation, a problem of a relatively long operation time caused by a plurality of iterative solving processes is avoided, and a dictionary obtaining speed is further increased.

In an optional implementation, the processor 701 is configured to: calculate a similarity between the first sparse facial feature and the second sparse facial feature; and if the similarity is greater than a similarity threshold, determine that a facial recognition result is success; or if the similarity is less than or equal to the similarity threshold, determine that the facial recognition result of the first face image is failure.

For implementation of each operation in FIG. 7, further correspondingly refer to the corresponding descriptions in the method embodiment shown in FIG. 4 or FIG. 5.

According to the facial recognition device shown in FIG. 7, the first face image and the second face image in different modalities may be mapped to the same cross-modal space by using a sparse representation method, and then facial recognition is performed on the first face image based on the first sparse facial feature obtained by mapping the first face image and the second sparse facial feature of the second face image. This facial recognition manner does not depend on acceleration of a GPU, reducing a requirement on a hardware device, increasing a facial recognition speed, and meeting a real-time requirement on facial recognition. In addition, the sparse representation method has a relatively low requirement on a data volume, so that an overfitting problem can be avoided.

Another embodiment provides a computer program product. When the computer program product runs on a computer, the method in the embodiment shown in FIG. 4 or FIG. 5 is implemented.

Another embodiment provides a computer-readable storage medium. The computer-readable storage medium stores a computer program, and when the computer program is executed by a computer, the method in the embodiment shown in FIG. 4 or FIG. 5 is implemented.

The foregoing descriptions are merely embodiments, but are not intended as limiting. Any modification or replacement readily figured out by a person of ordinary skill in the art within the scope disclosed in the embodiments shall fall within the protection scope.

What is claimed is:

1. A facial recognition method, comprising:
obtaining a first face image and a second face image, wherein the first face image is a current face image obtained by a camera, and the second face image is a stored reference face image;
determining whether a modality of the first face image is the same as a modality of the second face image;
when the modality of the first face image is different from that of the second face image, separately mapping the first face image and the second face image to a cross-modal space to obtain a first sparse facial feature of the first face image in the cross-modal space and a second sparse facial feature of the second face image in the cross-modal space, where the cross-modal space is a color space in which both a feature of the first face image and a feature of the second face image may be represented; and
performing facial recognition on the first face image based on the first sparse facial feature and the second sparse facial feature.

2. The method according to claim 1, wherein the separately mapping of the first face image and the second face image to a cross-modal space to obtain a first sparse facial feature of the first face image in the cross-modal space and a second sparse facial feature of the second face image in the cross-modal space comprises:
obtaining a first dictionary corresponding to the modality of the first face image and a second dictionary corresponding to the modality of the second face image;
mapping the first face image to the cross-modal space based on the first dictionary corresponding to the modality of the first face image, to obtain the first sparse facial feature of the first face image in the cross-modal space; and
mapping the second face image to the cross-modal space based on the second dictionary corresponding to the modality of the second face image, to obtain the second sparse facial feature of the second face image in the cross-modal space.

3. The method according to claim 2, wherein the obtaining of the first dictionary corresponding to the modality of the first face image and a second dictionary corresponding to the modality of the second face image comprises:
obtaining a feature representation matrix of a face image sample in the cross-modal space based on a first facial feature, a second facial feature, and an initialization dictionary by using a matching pursuit (MP) algorithm, wherein the first facial feature is a facial feature of the face image sample in the modality of the first face image, and the second facial feature is a facial feature of the face image sample in the modality of the second face image; and
determining, based on the first facial feature, the second facial feature, and the feature representation matrix by using a method of optimal directions (MOD) algorithm, the first dictionary corresponding to the modality of the first face image and the second dictionary corresponding to the modality of the second face image.

4. The method according to claim 1, wherein the determining whether a modality of the first face image is the same as a modality of the second face image comprises:
transforming the first face image and the second face image respectively from a red-green-blue RGB color space to a YCbCr space of a luma component, a blue-difference chroma component, and a red-difference chroma component;
determining a color coefficient value of the first face image and a color coefficient value of the second face image based on a value of the first face image in the YCbCr space and a value of the second face image in the YCbCr space; and
determining, based on the color coefficient value of the first face image and the color coefficient value of the second face image, whether the modality of the first face image is the same as the modality of the second face image.

5. The method according to claim 1, wherein the determining that modality of the first face image is different from the modality of the second face image occurs when one of the color coefficient value of the first face image and the color coefficient value of the second face image is greater than a first threshold, and the other color coefficient value is not greater than the first threshold.

6. The method according to claim 1, wherein the obtaining of a sparse facial feature is a manner of representing an original face image feature by using a linear combination of column vectors selected from a dictionary, and a manner of selecting a column vector is one of 0-norm constraint, 1-norm constraint, and 2-norm constraint.

7. The method according to claim 1, wherein the performing of facial recognition on the first face image based on the first sparse facial feature and the second sparse facial feature comprises:
calculating a similarity between the first sparse facial feature and the second sparse facial feature; and
if the similarity is greater than a similarity threshold, determining that a facial recognition result of the first face image is success; or
if the similarity is less than or equal to the similarity threshold, determining that the facial recognition result of the first face image is failure.

8. A facial recognition device, comprising a processor and a memory, wherein the memory is configured to store program instructions, and the processor is configured to:
obtain a first face image and a second face image, wherein the first face image is a current face image obtained by a camera, and the second face image is a stored reference face image;
determine whether a modality of the first face image is the same as a modality of the second face image;
when the modality of the first face image is different from that of the second face image, separately map the first face image and the second face image to a cross-modal space to obtain a first sparse facial feature of the first face image in the cross-modal space and a second sparse facial feature of the second face image in the cross-modal space, where the cross-modal space is a color space in which both a feature of the first face image and a feature of the second face image may be represented; and
perform facial recognition on the first face image based on the first sparse facial feature and the second sparse facial feature.

9. The device according to claim 8, wherein the separately mapping of the first face image and the second face image to a cross-modal space to obtain a first sparse facial feature of the first face image in the cross-modal space and a second sparse facial feature of the second face image in the cross-modal space comprises:
obtaining a first dictionary corresponding to the modality of the first face image and a second dictionary corresponding to the modality of the second face image;
mapping the first face image to the cross-modal space based on the first dictionary corresponding to the modality of the first face image, to obtain the first sparse facial feature of the first face image in the cross-modal space; and
mapping the second face image to the cross-modal space based on the second dictionary corresponding to the modality of the second face image, to obtain the second sparse facial feature of the second face image in the cross-modal space.

10. The device according to claim 9, wherein the obtaining of the first dictionary corresponding to the modality of the first face image and a second dictionary corresponding to the modality of the second face image comprises:
obtaining a feature representation matrix of a face image sample in the cross-modal space based on a first facial feature, a second facial feature, and an initialization dictionary by using a matching pursuit (MP) algorithm, wherein the first facial feature is a facial feature of the face image sample in the modality of the first face image, and the second facial feature is a facial feature of the face image sample in the modality of the second face image; and
determining, based on the first facial feature, the second facial feature, and the feature representation matrix by using a method of optimal directions (MOD) algorithm, the first dictionary corresponding to the modality of the first face image and the second dictionary corresponding to the modality of the second face image.

11. The device according to claim 10, wherein the obtaining of the feature representation matrix of the face image sample in the cross-modal space based on a first facial feature, a second facial feature, and an initialization dictionary by using the MP algorithm comprises:
solving a formula \hat{x}ᵢ=argₓ^{min}∥yᵢ-D₍₀₎x∥₂² subject to ∥x∥ₙ≤K by using the MP algorithm to obtain the feature representation matrix of the face image sample in the cross-modal space, wherein 1<i<M, yᵢ is an ith column vector of a matrix Y comprising the first facial feature and the second facial feature, a first row vector to an M^{th} row vector in the matrix Y are the first facial feature, an (M+1)^{th} row vector to a (2M)^{th} row vector are the second facial feature, \hat{x}ᵢ is an i^{th} column vector in the feature representation matrix in the cross-modal space, D₍₀₎ is the initialization dictionary, n represents a constraint manner of sparsing, and K is sparsity.

12. The device according to claim 10, wherein the determining, based on the first facial feature, of the second facial feature, and the feature representation matrix by using the MOD algorithm, of the first dictionary corresponding to the modality of the first face image and the second dictionary corresponding to the modality of the second face image comprises: solving a formula D=arg_{X}^{min}∥Y-DX∥_{F}²=YX^{T}(XX^{T})⁻¹ by using the MOD algorithm to obtain the first dictionary corresponding to the modality of the first face image and the second dictionary corresponding to the modality of the second face image, wherein D is a matrix comprising the first dictionary corresponding to the modality of the first face image and the second dictionary corresponding to the modality of the second face image, and X is the feature representation matrix.

13. The device according to claim 12, wherein D comprises M column vectors and 2M row vectors, a matrix comprising a first row vector to an M^{th} row vector is the first dictionary corresponding to the modality of the first face image, and a matrix comprising an (M+1)^{th} row vector to a (2M)^{th} row vector is the second dictionary corresponding to the modality of the second face image.

14. The device according to claim 9, wherein the mapping of the first face image to the cross-modal space based on the first dictionary corresponding to the modality of the first face image to obtain the first sparse facial feature of the first face image in the cross-modal space comprises:
determining, based on the first dictionary corresponding to the modality of the first face image and a penalty coefficient, a first projection matrix corresponding to the modality of the first face image; and
calculating the first sparse facial feature of the first face image in the cross-modal space by using the first projection matrix corresponding to the modality of the first face image and the first face image.

15. The device according to claim 9, wherein the mapping of the second face image to the cross-modal space based on the second dictionary corresponding to the modality of the second face image to obtain the second sparse facial feature of the second face image in the cross-modal space comprises:
determining, based on the second dictionary corresponding to the modality of the second face image and a penalty coefficient, a second projection matrix corresponding to the modality of the second face image; and
calculating the second sparse facial feature of the second face image in the cross-modal space by using the second projection matrix corresponding to the modality of the second face image and the second face image.

16. The device according to claim 8, wherein the determining whether a modality of the first face image is the same as a modality of the second face image comprises:
transforming the first face image and the second face image respectively from a red-green-blue RGB color space to a YCbCr space of a luma component, a blue-difference chroma component, and a red-difference chroma component;
determining a color coefficient value of the first face image and a color coefficient value of the second face image based on a value of the first face image in the YCbCr space and a value of the second face image in the YCbCr space; and
determining, based on the color coefficient value of the first face image and the color coefficient value of the second face image, whether the modality of the first face image is the same as the modality of the second face image.

17. The device according to claim 8, wherein determining that the modality of the first face image is different from the modality of the second face image occurs when one of the color coefficient value of the first face image and the color coefficient value of the second face image is greater than a first threshold, and the other color coefficient value is not greater than the first threshold.

18. The device according to claim 8, wherein the obtaining of a sparse facial feature is is a manner of representing an original face image feature by using a linear combination of column vectors selected from a dictionary, and a manner of selecting a column vector is one of 0-norm constraint, 1-norm constraint, and 2-norm constraint.

19. The device according to claim 8, wherein the performing of facial recognition on the first face image based on the first sparse facial feature and the second sparse facial feature comprises:
calculating a similarity between the first sparse facial feature and the second sparse facial feature; and
if the similarity is greater than a similarity threshold, determining that a facial recognition result of the first face image is success; or
if the similarity is less than or equal to the similarity threshold, determining that the facial recognition result of the first face image is failure.

20. A non-transitory computer-readable storage medium, comprising a program, wherein when being executed by a processor, the following steps are performed:
obtaining a first face image and a second face image, wherein the first face image is a current face image obtained by a camera, and the second face image is a stored reference face image;
determining whether a modality of the first face image is the same as a modality of the second face image;
when the modality of the first face image is different from that of the second face image, separately mapping the first face image and the second face image to a cross-modal space, to obtain a first sparse facial feature of the first face image in the cross-modal space and a second sparse facial feature of the second face image in the cross-modal space, where the cross-modal space is a color space in which both a feature of the first face image and a feature of the second face image may be represented; and
performing facial recognition on the first face image based on the first sparse facial feature and the second sparse facial feature.
